(19) United States
(12) Patent Application Publication
(10) Pub. No.: US 2008/0108471 A1
(43) Pub. Date: May 8, 2008

(54) Lubrication ports for a differential housing

(76) Inventors: Laurence A. Deutsch, Farmington Hills, MI (US); Steven G. Thomas, Bloomfield Hills, MI (US)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 11/591,830

(22) Filed: Nov. 2, 2006

(51) Int. Cl. F16H 57/04; F16H 48/06; F16H 57/08

(52) U.S. Cl. 475/160; 475/220; 475/331

(57) ABSTRACT

Apparatus for transmitting torque in a vehicular differential assembly includes a ring gear surrounding a first axis about which the housing rotates; and a differential housing secured to the ring gear, including a wall surrounding the first axis and formed with a port spaced mutually about the first axis and extending through a thickness of the wall, a periphery of the port being a oval defined by first and second opposed straight edge portions, each straight edge portion located on an opposite side of a second axis, and an arcuate corner portion located at each end of each straight edge portion, the second axis being inclined with respect to the first axis in an angular range from 20 degrees to 50 degrees.

### BACKGROUND OF THE INVENTION

1. Field of the Invention

The present invention relates generally to automotive differential mechanisms and, more particularly, to a differential housing having a series of lubrication ports formed through its wall thickness.

2. Description of the Prior Art

A differential mechanism transmits rotary power differentially to output shafts from a ring gear driven by an external power source, such as an internal combustion engine or electric motor. A housing, formed of metal and secured to the ring gear, defines a chamber containing bevel pinions driveably connected to the housing 14 by a spindle, a right-side bevel gear and a left-side bevel gear in continuous meshing engagement with the bevel pinions. The side bevel gears are driveably connected to a right-side output shaft and left-side output shaft, each shaft being driveably connected to a wheel of the vehicle.

The housing chamber is surrounded by a wall having a thickness and multiple ports formed in the wall, spaced mutually about an axis of rotation and passing through the wall thickness to the chamber in the housing. The ports provide access to the interior of the housing, whereby hydraulic lubricant located outside the housing can flow to the interior. The ring gear rotates through a fluid sump containing hydraulic lubricant, such as automatic-transmission fluid (ATF). In addition, a pump may draw lubricant from the sump. As the ring gear and other components of the differential apparatus rotate, the ATF is carried from the sump on the surfaces of the ring gear teeth and pump, and is slung onto the outer surface of the housing 14, from which it migrates through the ports into the housing. The ATF lubricates the bevel gears and side gears located in the chamber.

The lubrication ports produce discontinuities in the housing wall. The housing transmits torque. The port discontinuities are stress risers, which affect the magnitude of stress in the housing wall due to the transmitted loads and influence deflection of the housing due to these loads. The ports can neither be eliminated nor reduced in size because a smaller size would decrease the flow rate of lubricant entering the differential housing, potentially compromising the performance of the differential components.

There is a need, therefore, to optimize the configuration of the lubrication ports in a differential housing such that the supply of lubricant to the interior of the housing is sufficient, without increasing the magnitude of the material stress and deflection and without reducing the endurance or fatigue life of the differential housing.

### SUMMARY OF THE INVENTION

A differential mechanism for transmitting torque in a vehicular differential assembly includes a ring gear surrounding a first axis about which the housing rotates; and a differential housing secured to the ring gear, including a wall surrounding the first axis and formed with a port spaced mutually about the first axis and extending through a thickness of the wall, a periphery of the port being a oval defined by first and second opposed straight edge portions, each straight edge portion located on an opposite side of a second axis, and an arcuate corner portion located at each end of each straight edge portion, the second axis being inclined with respect to the first axis in an angular range from 20 degrees to 50 degrees.

The ports, as originally designed, were oblong and aligned with the axis of rotation. It was discovered that by skewing the ports at an optimum angle, the stresses would be reduced substantially and the fatigue life increased without reducing the area of a port. Alternatives to reconfiguring the ports include increasing the wall thickness of the housing to reduce the stresses and increasing the strength of the material from which the housing is formed.

Increasing the housing wall thickness would have increased the package space required to contain the housing and would have increased the weight of the housing. Changing the material to a higher strength material would have added to material costs. By reconfiguring the lubrication ports, no increase in size, weight, or cost of the housing is required.

The scope of applicability of the preferred embodiment will become apparent from the following detailed description, claims and drawings. It should be understood, that the description and specific examples, although indicating preferred embodiments of the invention, are given by way of illustration only. Various changes and modifications to the described embodiments and examples will become apparent to those skilled in the art.

### DESCRIPTION OF THE DRAWINGS

The above and further objects and advantages of the invention will become apparent to those skilled in the art from the following detailed description of the best mode currently contemplated for the preferred embodiment, when considered in light of the accompanying drawings and claims, of which:

FIG. 1 is a cross section of a differential mechanism for use in the driveline of a motor vehicle;

FIG. 2 is a side view of the differential housing shown in FIG. 1;

FIG. 3 is a perspective view of a differential housing shown in FIG. 1;

FIG. 4 is top view of a port formed in the differential housing;

FIG. 5 is a top view of an alternate embodiment of a port formed in the differential housing;

FIG. 6 is a top view of an alternate embodiment of a port formed in the differential housing;

FIG. 7 is a top view of an alternate embodiment of a port formed in the differential housing;

FIG. 8 is a top view of an alternate embodiment of a port formed in the differential housing; and

FIG. 9 is a top view of an alternate embodiment of a port formed in the differential housing.

### DESCRIPTION OF THE PREFERRED EMBODIMENT

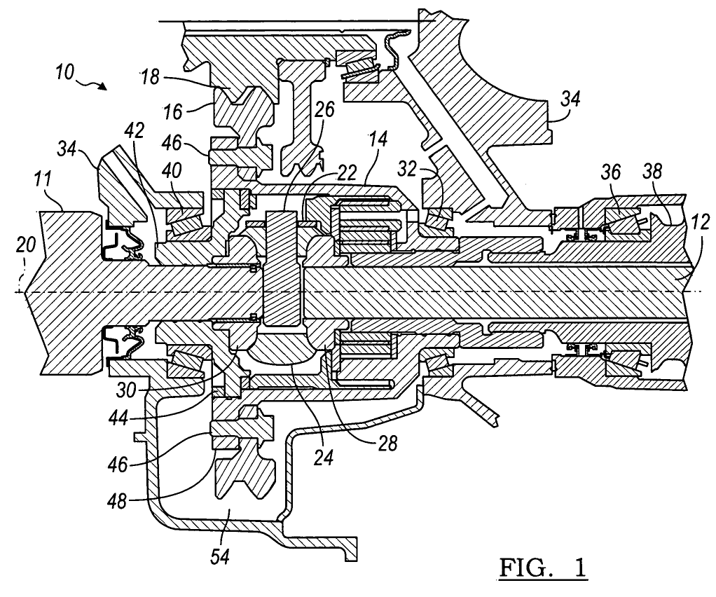

Referring first to FIG. 1, a differential mechanism 10 for transmitting torque, in the form of rotary power, differentially to a left-side half-shaft 11 and right-side half-shaft includes a housing 14, formed of metal, preferably cast iron, and a ring gear 16 formed with helical gear teeth 18 and driveably connected to an external power source. The ring gear 16, housing 14 and half-shafts 11, 12 rotate about a first axis 20. Bevel pinions 22, 24, driveably connected to the housing 14 by a spindle, revolve about axis 20, and rotate about the axis of spindle 26. A right-side bevel gear 28 and a left-side bevel gear 30 are in continuous meshing engagement with the bevel pinions 22, 24. The side bevel gears 28, 30 are driveably connected, respectively, to a right-side half-shaft 12 and the left-side half-shaft 11, each half-shaft being driveably connected to a wheel of the vehicle.

The right-side half-shaft 12 is supported for rotation on a bearing 32, fitted between housing 14 and a casing 34, and on a bearing 36, fitted between casing 34 and a power take-off shaft 38. Similarly the left-side half-shaft 11 is supported on a bearing 40, fitted between an end cap 42 and casing 34.

End cap 42 is secured to housing 14 by a ring nut 44. Ring gear 16 is secured to housing 14 by a series of bolts 46 arranged in a bolt circle on a flange 48 formed integrally with the housing 14.

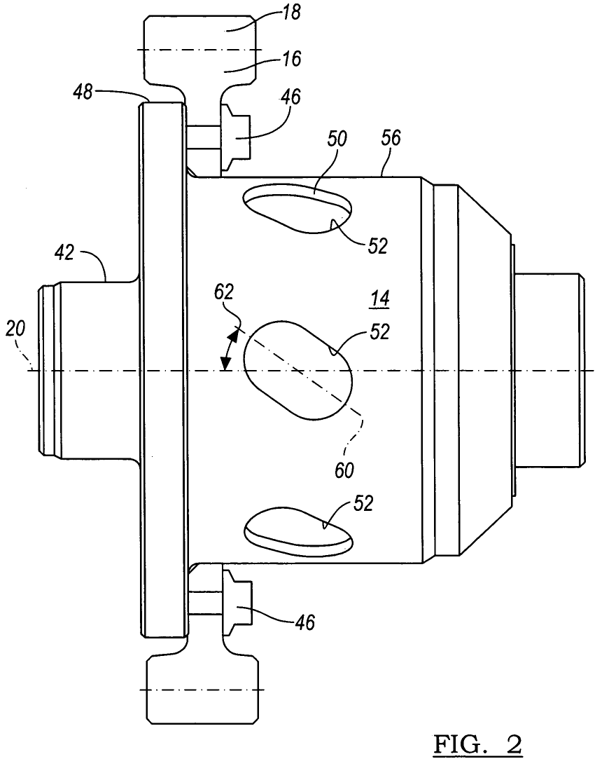

FIG. 2 illustrates the housing 14, its wall 50 having a thickness, and multiple ports 52 formed in the wall, spaced mutually about axis 20 and passing through the wall thickness to the interior of the housing. The ports 52 provide access to the interior of the housing, whereby hydraulic lubricant located outside the housing can flow to the interior. As FIG. 1 shows, the ring gear 16 rotates through a fluid sump 54 containing hydraulic lubricant, such as automatic transmission fluid (ATF). As the ring gear 16 and other components of the differential apparatus rotate, ATF is carried from the sump 54 on the surfaces of the ring gear teeth 18 and/or pump, and is slung onto the outer surface 56 of housing 14, from which it migrates through the ports 52 into the housing. The ATF lubricates the bevel gears 22, 24 and side gears 28, 30 located in housing 14. Each port 52 has a second axis 60 that is inclined with respect to axis 20 at an angle 62 having a range between 20° and 50°.

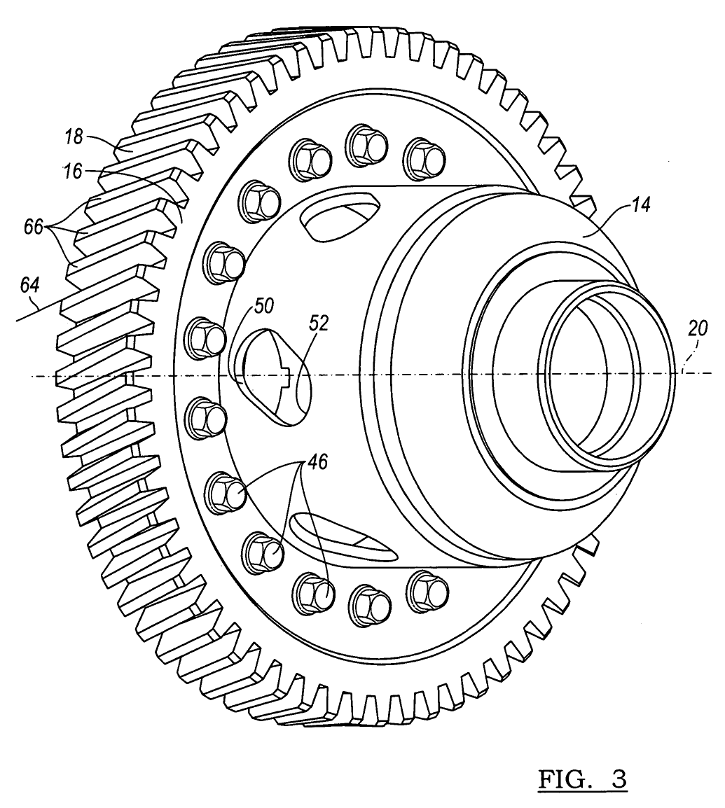

FIG. 3 shows that the gear teeth 18 of the ring gear 16 are preferably helical gear teeth. A line 64 along the crest 66 of each tooth is inclined with respect to axis 20.

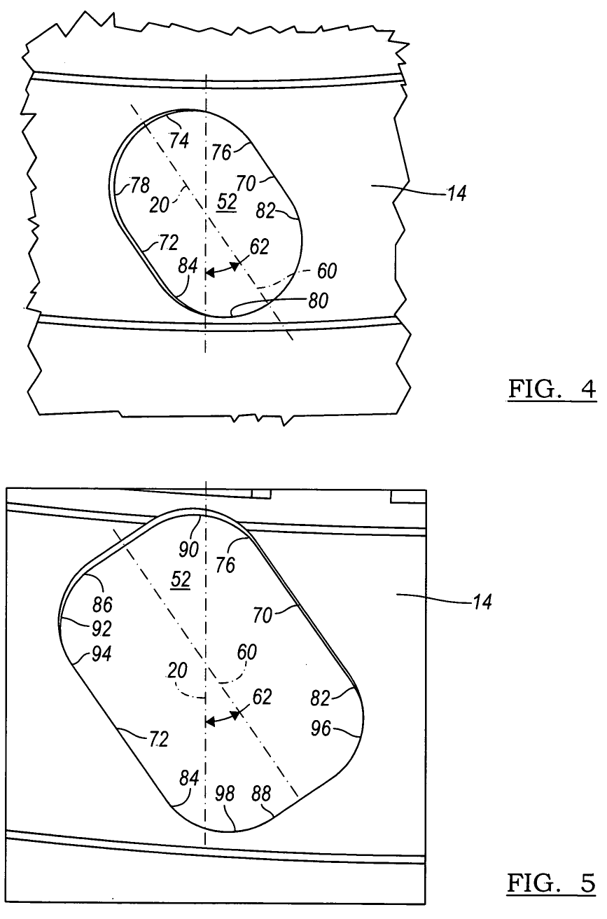

Referring now to FIG. 4, the port 52 is an oval whose periphery is defined by first and second opposed straight edge portions 70, 72. Each straight edge portion 70, 72 is located on an opposite side of second axis 60 and is substantially parallel to axis 60. A first arcuate corner portion 74 is located at the first end 76 of the first straight edge portion 70 and extends to the first end 78 of the second straight edge portion 72. A second arcuate corner portion 80 is located at the second end 82 of the first straight edge portion 70 and extends to the second end 84 of the second straight edge portion 72. The second axis is shown inclined with respect to the first axis 20 at an angle 62 in an angular range from 20 degrees to 50 degrees. Preferably, the first arcuate corner portion 74 is a circular arc, and second arcuate corner portion 80 is a circular arc. The length of port 52 along axis 60 is about 34 mm. and the width of port normal to axis 60 is about 24 mm.

Referring now to FIG. 5, the port 52 is an oval whose periphery is defined by first and second opposed straight edge portions 70, 72 and third and fourth straight edge portions 86, 88, which are spaced mutually along second axis 60 and arranged substantially mutually parallel. Each straight edge portion 70, 72 is located on an opposite side of second axis 60 and is substantially parallel to axis 60. A first arcuate corner portion 90 extends from the first end 76 of the first straight edge portion 70 to the third straight edge portion 86. A second arcuate corner portion 92 extends from the first end 94 of the second straight edge portion 72 to the third straight edge portion 86. A third arcuate corner portion 96 extends from the second end 82 of the first straight edge portion 70 to the fourth straight edge portion 88. A fourth arcuate corner portion 98 extends from the second end 84 of the second straight edge portion 72 to the fourth straight edge portion 88. The second axis 60 is shown inclined with respect to the first axis 20 at an angle 62 in an angular range from 20 degrees to 50 degrees. Preferably, the arcuate corner portions 90, 92, 96, 98 are circular arcs.

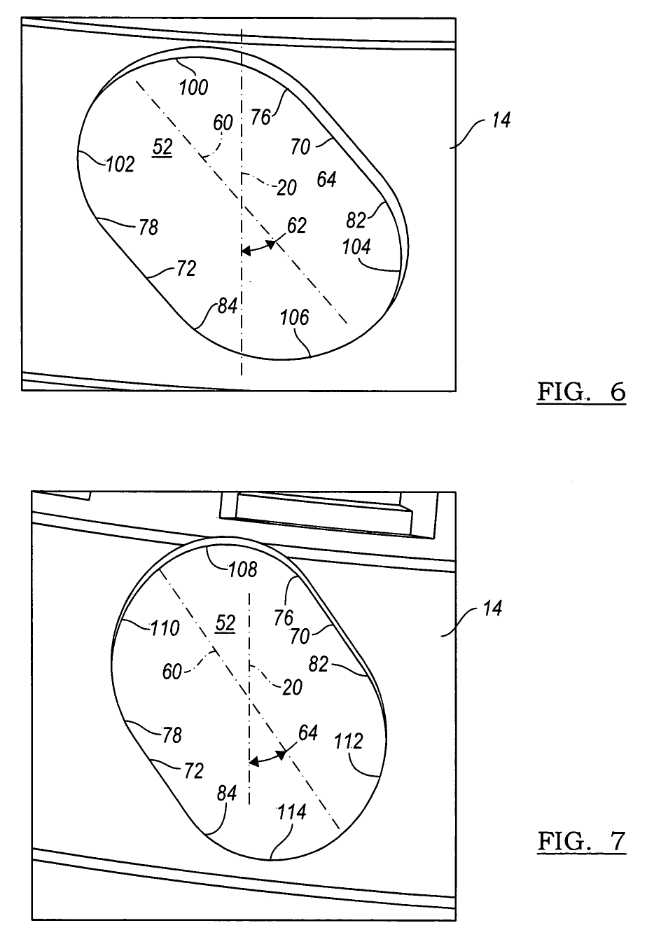

Referring now to FIG. 6, the port 52 is an oval whose periphery is defined by first and second opposed straight edge portions 70, 72. Each straight edge portion 70, 72 is located on an opposite side of second axis 60 and is substantially parallel to axis 60. A first arcuate corner portion 100 extends from the first end 76 of the first straight edge portion 70 toward the second straight edge portion 72. A second arcuate corner portion 102 extends from the first end 78 of the second straight edge portion 72 to the first arcuate corner portion 100. A third arcuate corner portion 104 extends from the second end 82 of the first straight edge portion 70 toward the second straight edge portion 72. A fourth arcuate corner portion 106 extends from the second end 84 of the second straight edge portion 72 to the third arcuate corner portion 104. The second axis 60 is shown inclined with respect to the first axis 20 at an angle 62 in an angular range from 20 degrees to 50 degrees. Preferably, the arcuate corner portions 100, 102, 104, 106 are circular arcs. Preferably, the radius arcuate corner portions 100, 106 are larger than the radius of arcuate corner portions 102, 104.

Referring now to FIG. 7, the port 52 is an oval whose periphery is defined by first and second opposed straight edge portions 70, 72. Each straight edge portion 70, 72 is located on an opposite side of second axis 60 and is substantially parallel to axis 60. A first arcuate corner portion 108 extends from the first end 76 of the first straight edge portion 70 toward the second straight edge portion 72. A second arcuate corner portion 110 extends from the first end 78 of the second straight edge portion 72 to the first arcuate corner portion 108. A third arcuate corner portion 112 extends from the second end 82 of the first straight edge portion 70 toward the second straight edge portion 72. A fourth arcuate corner portion 114 extends from the second end 84 of the second straight edge portion 72 to the third arcuate corner portion 112. The second axis 60 is shown inclined with respect to the first axis 20 at an angle 62 in an angular range from 20 degrees to 50 degrees. Preferably, the arcuate corner portions 108, 110, 112, 114 are circular arcs. Preferably, the radius of arcuate corner portions 110, 112 are larger than the radius of arcuate corner portions 108, 114.

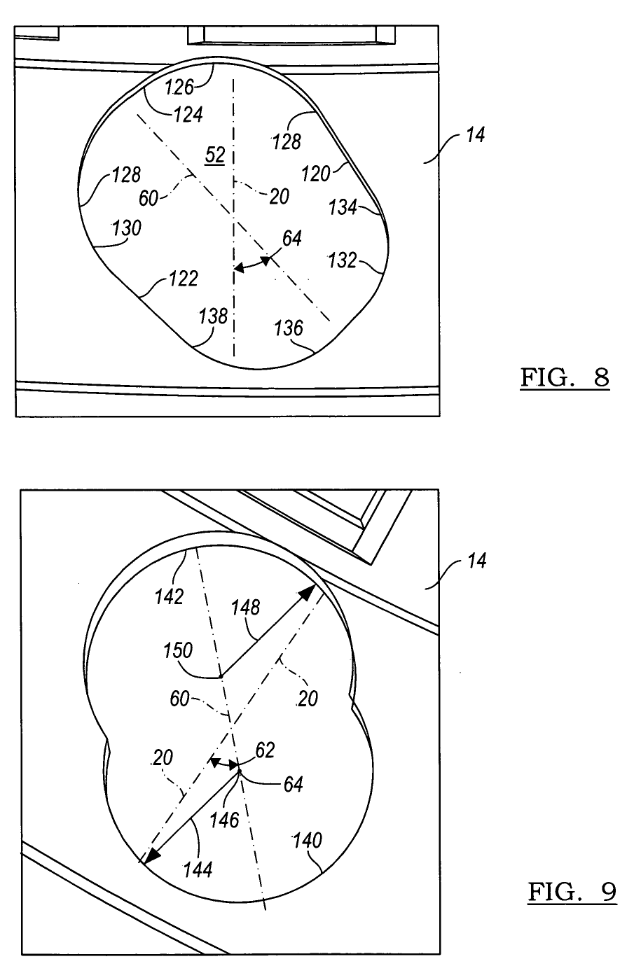

Referring now to FIG. 8, the port 52 is an oval whose periphery is defined by first and second opposed straight edge portions 120, 122 and a third straight edge portion 124. Each straight edge portion 70, 72 is located on an opposite side of second axis 60 and is skew at an angle with respect to axis 60, such that the port 52 is wider at the end where third straight edge portion 124 is located than at the opposite end. A first arcuate corner portion 126 extends from the first end 128 of the first straight edge portion 120 to the third straight edge portion 124. A second arcuate corner portion 128 extends from the first end 130 of the second straight edge portion 122 to the third straight edge portion 124. A third arcuate corner portion 132 extends from the second end 134 of the first straight edge portion 120 toward the second straight edge portion 122. A fourth arcuate corner portion 136 extends from the second end 138 of the second straight edge portion 122 to the third arcuate corner 132. The second axis 60 is shown inclined with respect to the first axis 20 at an angle 62 in an angular range from 20 degrees to 50 degrees. Preferably, the arcuate corner portions 126, 128, 132, 136 are circular arcs, and the radii of the arcuate corner portions 126, 128, 132, 136 are mutually equal.

Referring now to FIG. 9, the periphery of port 52 is defined by first and second circular arcs 140, 142. Are has a radius 144 and a center 146; arc has a radius 148 and a center 150. The centers 146, 150 are located on second axis 60, the distance between the centers being less than the radius of either the first and second arcs. The second axis 60 is shown inclined with respect to the first axis 20 at an angle 62 in an angular range from 20 degrees to 50 degrees. The length of port 52 along axis 60 is about 34 mm. and the width of port normal to axis 60 is about 24 mm.

In accordance with the provisions of the patent statutes, the preferred embodiment has been described. However, it should be noted that the alternate embodiments can be practiced otherwise than as specifically illustrated and described.

What is claimed is:

1. Apparatus for transmitting torque in a vehicular differential assembly, comprising:
a ring gear surrounding a first axis about which the ring gear rotates; and
a differential housing secured to the ring gear, including a wall surrounding the first axis and formed with a port spaced mutually about the first axis and extending through a thickness of the wall, a periphery of the port being a oval defined by first and second opposed straight edge portions, each straight edge portion located on an opposite side of a second axis, and arcuate corner portions, each arcuate corner portion being located at an end of each straight edge portion, the second axis being inclined with respect to the first axis in an angular range from 20 degrees to 50 degrees.

2. The apparatus of claim 1 wherein:
each straight edge portion is substantially parallel to the second axis;
a first arcuate corner portion that extends in a circular arc from a first end of the first straight edge portion to a first end of the second straight edge portion; and
a second arcuate corner portion that extends in a circular arc from a second end of the first straight edge portion to a second end of the second straight edge portion.

3. The apparatus of claim 1 wherein:
the oval periphery of the port is further defined by third and fourth opposed straight edge portions, spaced mutually along the second axis and arranged substantially mutually parallel;
each straight edge portion is substantially perpendicular to the second axis;
a first arcuate corner portion that extends in a circular arc from a first end of the first straight edge portion to a first end of the third straight edge portion;
a second arcuate corner portion that extends in a circular arc from a first end of the second straight edge portion to a second end of the third straight edge portion;
a third arcuate corner portion that extends in a circular arc from a second end of the first straight edge portion to a first end of the fourth straight edge portion; and
a fourth arcuate corner portion that extends in a circular arc from a second end of the second straight edge portion to a second end of the fourth straight edge portion.

4. The apparatus of claim 1 wherein:
each straight edge portion is substantially parallel to a respective second axis;
a first arcuate corner portion having a first radius that extends in a circular arc from a first end of the first straight edge portion toward the second straight edge portion;
a second arcuate corner portion having a radius smaller than the first radius and that extends in a circular arc from a first end of the second straight edge portion toward the first arcuate corner portion;
a third arcuate corner portion having a radius that extends in a circular arc from a second end of the first straight edge portion toward the first straight edge portion; and
a fourth arcuate corner portion having a radius smaller than the first radius and that extends in a circular arc from a second end of the second straight edge portion toward the third arcuate corner portion.

5. The apparatus of claim 1 wherein:
each straight edge portion is substantially parallel to a respective second axis;
a first arcuate corner portion having a first radius that extends in a circular arc from a first end of the first straight edge portion toward the second straight edge portion;
a second arcuate corner portion having a radius larger than the first radius and that extends in a circular arc from a first end of the second straight edge portion toward the first arcuate corner portion;
a third arcuate corner portion having a radius larger than the first radius and that extends in a circular arc from a second end of the first straight edge portion toward the first straight edge portion; and
a fourth arcuate corner portion having a radius that extends in a circular arc from a second end of the second straight edge portion toward the third arcuate corner portion.

6. The apparatus of claim 1 wherein:
each straight edge portion is skewed with respect to the second axis;
a first arcuate corner portion having a radius that extends in a circular arc from a first end of the first straight edge portion toward the second straight edge portion;
a second arcuate corner portion having a radius that extends in a circular arc from a first end of the second straight edge portion toward the first arcuate corner portion;
a third arcuate corner portion having a radius that extends in a circular arc from a second end of the first straight edge portion toward the first straight edge portion; and
a fourth arcuate corner portion having a radius that extends in a circular arc from a second end of the second straight edge portion toward the third arcuate corner portion.

7. The apparatus of claim 1 further comprising:
multiple ports formed in the housing wall and spaced mutually about the first axis.

8. Apparatus for transmitting torque in a vehicular differential assembly, comprising:
a ring gear surrounding a first axis about which the housing rotates; and
a differential housing secured to the ring gear, including a wall surrounding the first axis and formed with a port spaced mutually about the first axis and extending through a thickness of the wall, a periphery of the port being defined by first and second circular arcs, each arc having a radius and a center, the centers being located on a second axis inclined with respect to the first axis in an angular range from 20 degrees to 50 degrees, a distance between the centers being less than the radius of either the first or second arc.

9. The apparatus of claim 8 further comprising:
multiple ports formed in the housing wall and spaced mutually about the first axis.

10. A differential assembly for a motor vehicle comprising:
a ring gear surrounding a first axis about which the ring gear rotates;
a differential housing secured to the ring gear, including a wall surrounding the first axis, a chamber surrounded by the wall, the wall being formed with a port spaced mutually about the first axis and extending through a thickness of the wall, a periphery of the port being a oval defined by first and second opposed straight edge portions, each straight edge portion located on an opposite side of a second axis, and arcuate corner portions, each arcuate corner portion being located at an end of each straight edge portion, the second axis being inclined with respect to the first axis in an angular range from 20 degrees to 50 degrees;
output shafts extending in opposite directions from the housing; and
differential gearing located in the chamber and driveably connected to the output shafts, for transmitting power from the ring gear to the output shafts differentially.

11. The apparatus of claim 10 wherein each straight edge portion is substantially parallel to the second axis.

12. The apparatus of claim 10 wherein:
each straight edge portion is substantially parallel to the second axis;
a first arcuate corner portion that extends in a circular arc from a first end of the first straight edge portion to a first end of the second straight edge portion; and
a second arcuate corner portion that extends in a circular arc from a second end of the first straight edge portion to a second end of the second straight edge portion.

13. The apparatus of claim 10 wherein:
the oval periphery of the port is further defined by third and fourth opposed straight edge portions, spaced mutually along the second axis and arranged substantially mutually parallel, and perpendicular to the second axis;
a first arcuate corner portion that extends in a circular arc from a first end of the first straight edge portion to a first end of the third straight edge portion;
a second arcuate corner portion that extends in a circular arc from a first end of the second straight edge portion to a second end of the third straight edge portion;
a third arcuate corner portion that extends in a circular arc from a second end of the first straight edge portion to a first end of the fourth straight edge portion; and
a fourth arcuate corner portion that extends in a circular arc from a second end of the second straight edge portion to a second end of the fourth straight edge portion.

14. The apparatus of claim 10 wherein:
each straight edge portion is substantially parallel to a respective second axis;
a first arcuate corner portion having a first radius that extends in a circular arc from a first end of the first straight edge portion toward the second straight edge portion;
a second arcuate corner portion having a radius smaller than the first radius and that extends in a circular arc from a first end of the second straight edge portion toward the first arcuate corner portion;
a third arcuate corner portion having a radius that extends in a circular arc from a second end of the first straight edge portion toward the first straight edge portion; and
a fourth arcuate corner portion having a radius smaller than the first radius and that extends in a circular arc from a second end of the second straight edge portion toward the third arcuate corner portion.

15. The apparatus of claim 10 wherein:
each straight edge portion is substantially parallel to a respective second axis;
a first arcuate corner portion having a first radius that extends in a circular arc from a first end of the first straight edge portion toward the second straight edge portion;
a second arcuate corner portion having a radius larger than the first radius and that extends in a circular arc from a first end of the second straight edge portion toward the first arcuate corner portion;
a third arcuate corner portion having a radius larger than the first radius and that extends in a circular arc from a second end of the first straight edge portion toward the first straight edge portion; and
a fourth arcuate corner portion having a radius that extends in a circular arc from a second end of the second straight edge portion toward the third arcuate corner portion.

16. The apparatus of claim 10 wherein:
each straight edge portion is skewed with respect to the second axis;
a first arcuate corner portion having a radius that extends in a circular arc from a first end of the first straight edge portion toward the second straight edge portion;
a second arcuate corner portion having a radius that extends in a circular arc from a first end of the second straight edge portion toward the first arcuate corner portion;
a third arcuate corner portion having a radius that extends in a circular arc from a second end of the first straight edge portion toward the first straight edge portion; and
a fourth arcuate corner portion having a radius that extends in a circular arc from a second end of the second straight edge portion toward the third arcuate corner portion.

17. The apparatus of claim 10 further comprising:
multiple ports formed in the housing wall and spaced mutually about the first axis.
